(19) United States
(12) Patent Application Publication
(10) Pub. No.: US 2025/0039091 A1
(43) Pub. Date: Jan. 30, 2025

(54) CONTROL SYSTEM, ROUTER, CONTROL METHOD, AND PROGRAM

(71) Applicant: NEC Corporation, Minato-ku, Tokyo (JP)

(72) Inventor: Naruaki MAEDA, Tokyo (JP)

(73) Assignee: NEC Corporation, Minato-ku, Tokyo (JP)

(21) Appl. No.: 18/841,443

(22) PCT Filed: Mar. 14, 2022
(86) PCT No.: PCT/JP2022/011371

§ 371 Date: Aug. 26, 2024

(51) Int. Cl. H04L 45/85; H04L 9/40; H04L 43/0882; H04L 45/00; H04L 47/125

(52) U.S. Cl. CPC H04L 45/85; H04L 43/0882; H04L 45/22; H04L 47/125; H04L 63/1425

(57) ABSTRACT

A control system includes: a server monitoring part that monitors a public server accessible via lines of at least two Internet service providers; and a router, wherein the server monitoring part notifies load information indicating a load state of the public server, and the router includes: a selection part that selects an Internet service provider according to the load information notified by the server monitoring part; and a control part that determines a delivery route in such a way that a packet is delivered through a line of the Internet service provider selected by the selection part.

### TECHNICAL FIELD

The present invention relates to a control system, a router, a control method, and a program.

### BACKGROUND ART

In critical systems, it is prepared to maintain operations even during denial-of-service attacks by ensuring processing capacity beyond what is typically required by the system. For instance, the requirement for counter measures based on the government's unified standard guidelines include the following:
Ensure processing performance by load balancing apparatuses.
Install alternative equipment.
Restrict or block communication on the basis of the source addresses of denial-of-service attacks and a characteristics of communication packets.
Temporarily expand bandwidths of communication line apparatuses and communication lines during periods of massive accesses.
Isolation of terminals, servers, and communication lines used for managing an information system from those used for providing services.

Further, there are four types of security breaches that a system should consider: denial-of-service (DOS) attacks, malicious program infections, targeted attacks, and unauthorized access (internal fraud). There are automatic defense products that aim to disconnect nodes determined to be breached by malicious program infections or targeted attacks from the network, but there are no product that seeks to automatically deal with DOS attacks.

Patent Literature (PTL) 1 relates to an unauthorized access prevention system.

PTL 2 relates to a cluster control method.

PTL 3 relates to an information processing apparatus.

PTL 4 describes a router that determines whether to forward a received packet to an Internet service provider A by forwarding the packet to another router via a LAN or to an Internet service provider B connected via a WAN when a user simultaneously subscribes to a plurality of Internet service providers.

### CITATION LIST

### Patent Literature

PTL 1: Japanese Patent Kokai Publication No. JP2008-011008A
PTL 2: Japanese Patent Kokai Publication No. JP2010-113495A
PTL 3: Japanese Patent Kokai Publication No. JP2011-030145A
PTL 4: Japanese Patent Kokai Publication No. JP2000-209278A

### SUMMARY

### Technical Problem

The following analysis is provided by the present invention.

Even with Patent Literatures 1 to 4, there remains a problem that an increase in packet throughput cannot be dealt with when there is an external attack on a public server.

It is an object of the present invention to provide a control system, router, a control method, and a program that enable coping with an increase in packet throughput for a public server.

### Solution to Problem

According to a first aspect of the present invention, there can be provided a control system, including:
a server monitoring part that monitors a public server accessible via lines of at least two Internet service providers; and
a router, wherein
the server monitoring part notifies load information indicating a load state of the public server, and
the router includes:
a selection part that selects an Internet service provider according to the load information notified by the server monitoring part; and
a control part that determines a delivery route in such a way that a packet is delivered through a line of the Internet service provider selected by the selection part.

According to a second aspect of the present invention, there can be provided a control method, including: executed by a computer,
a server monitoring step of monitoring a public server accessible via lines of at least two Internet service providers: wherein the server monitoring step comprises notifying load information indicating a load state of the public server;
a selection step of selecting an Internet service provider according to the load information notified by the server monitoring step; and
a control step of determining a delivery route in such a way that a packet is delivered through a line of the Internet service provider selected by the selection step.

According to a third aspect of the present invention, there can be provided a program causing a computer to execute:
a server monitoring process of monitoring a public server accessible via lines of at least two Internet service providers;
wherein the server monitoring process comprises notifying load information indicating a load state of the public server;
a selection process of selecting an Internet service provider according to the load information notified by the server monitoring process; and
a control process of determining a delivery route in such a way that a packet is delivered through a line of the Internet service provider selected by the selection process. Further, this program can be stored in a computer-readable storage medium. The storage medium may be a non-transitory one such as a semiconductor memory, a hard disk, a magnetic recording medium, an optical recording medium, and the like. The present invention can also be realized as a computer program product.

### Advantageous Effects of Invention

According to the present invention, it becomes possible to cope with an increase in packet throughput for a public server.

### BRIEF DESCRIPTION OF DRAWINGS

FIG. 1 is a diagram illustrating an example of a schematic configuration of a control system according to an example embodiment of the present invention.

FIG. 2 is a diagram illustrating an example of a schematic configuration of a control system according to a first example embodiment of the present invention.

FIG. 3 is a flowchart showing an example of an outline of an operation of the control system according to the first example embodiment of the present invention.

FIG. 4 is a diagram illustrating an example of a schematic configuration of an example of utilizing a control system according to a second example embodiment of the present invention.

FIG. 5 is a flowchart showing an example of an outline operation of an example of utilizing the control system according to the second example embodiment of the present invention.

FIG. 6 is a diagram illustrating the configuration of a computer making up the control system of the present invention.

### DETAILED DESCRIPTION

First, an outline of an example embodiment of the present invention will be given with reference to the drawings. It should be noted that the drawing reference signs in the outline are given to each element for convenience as an example to facilitate understanding and are not intended to limit the present invention to the illustrated modes. Further, connection lines between blocks in the drawings referred to in the following description can be both bidirectional and unidirectional. A unidirectional arrow schematically shows a flow of a main signal (data) and does not exclude bidirectionality.

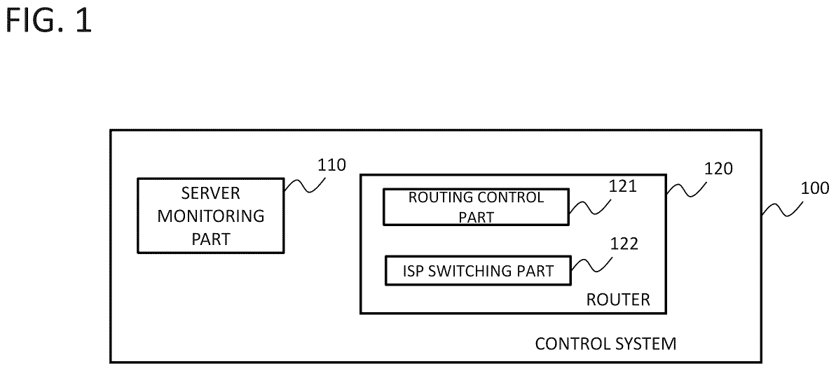

FIG. 1 is a diagram illustrating an example of a schematic configuration of a control system of an example embodiment of the present invention. With reference to FIG. 1, the control system 100 of an example embodiment of the present invention includes a server monitoring part 110 and a router 120 (hereinafter also referred to as the router), and the router 120 includes a routing control part 121 (hereinafter also referred to as the control part) and an Internet service provider (ISP) switching part 122 (hereinafter also referred to as the selection part). In an example embodiment of the present invention, a server published on the Internet is referred to as a public server. An Internet service provider provides Internet connection services. A public server is accessible via lines of at least two Internet service providers. In other words, a public server subscribes to at least two Internet service providers (hereinafter also referred to as a first provider and a second provider).

The server monitoring part 110 monitors a load on a public server and notifies information indicating a load state thereof. The load state is, for instance, a high load state. A high load state occurs when the public server suffers a denial-of-service attack or a distributed denial-of-service (DDos) attack.

An ISP switching part 122 of the router 120 selects an Internet service provider according to information indicating a high load state notified by the server monitoring part 110.

A routing control part 121 of the router 120 determines a delivery route according to the destination of an outgoing packet in such a way that an outgoing packet is delivered through a line of the Internet service provider selected by the ISP switching part 122.

In a system configuration with a public server subscribing to at least two Internet service providers, the control system of an example embodiment of the present invention is able to monitor a server load by measuring a usage of the public server and automatically switch the Internet service provider as an initial response before an increase in the server load affects services provided by the public server.

As a result, when a denial-of-service attack on a public server is detected due to an increase in a server load on a public server, it is possible to take measures to prevent denial-of-service attacks thereafter without operator intervention and suppress an increase in a processing amount of malicious packets in a router.

Therefore, according to a control system of the example embodiment of the present invention, by detecting a rapid decrease in a processing capacity of a public server due to a denial-of-service attack and the like, it is possible to provide a control system that contributes to enabling the suppression of an increase in a processing amount of malicious packets in a router.

### First Example Embodiment

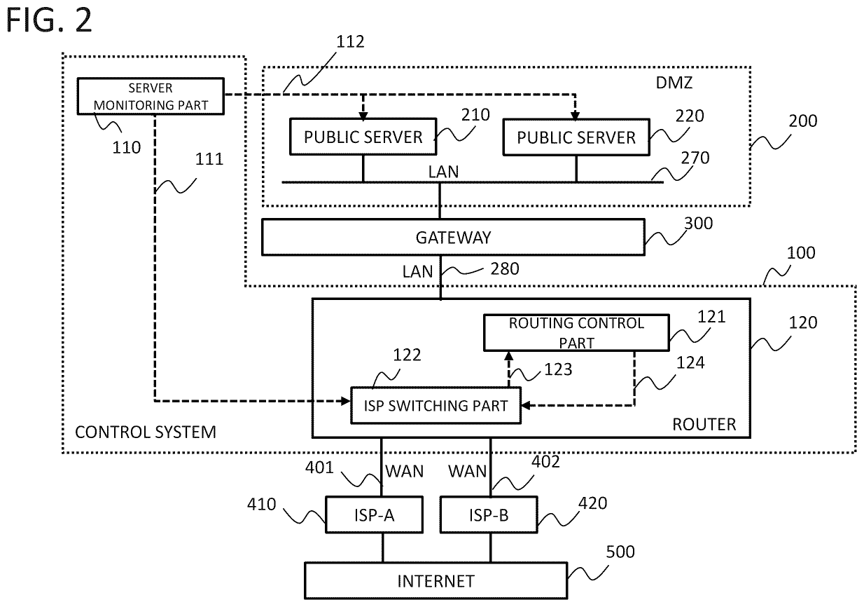

Next, the following describes an example of the configuration of a control system according to a first example embodiment of the present invention with reference to the drawings. FIG. 2 is a diagram illustrating an example of a schematic configuration of the control system according to the first example embodiment of the present invention.

With reference to FIG. 2, a control system 100 includes a server monitoring part 110 and a router 120. The server monitoring part 110 of the control system 100 may be configured to be provided independently of the router 120 and be connected to the router 120 by a network, or the like. Alternatively, the control system 100 as a control apparatus may be configured in such way that the server monitoring part 110 and the router 120 are provided therein. The router 120 includes a routing control part 121 and an Internet service provider (ISP) switching part 122. The routing control part 121 and the ISP switching part 122 are connected by control lines 123 and 124. The server monitoring part 110 is connected to the ISP switching part 122 of the router 120 via a control line 111. When provided independently of the router 120, the server monitoring part 110 may be connected to the ISP switching part 122 via a network, instead of the control line 111. In the first example embodiment of the present invention, solid lines indicate data lines and dotted lines indicate control lines. Further, a server published on the Internet is also referred to as the public server in the first example embodiment of the present invention.

With reference to FIG. 2, as an example, provided are public servers 210 and 220 subscribing to at least two Internet service providers ISP-A410 and ISP-B420, and the public servers 210 and 220 and a gateway 300 are connected to a local area network (LAN) 270. The gateway 300 is connected to the router 120 by a local area network (LAN) 280. The gateway 300 may be connected to the ISP switching part 122 of the router 120 by, for instance, the local area network (LAN) 280. The server monitoring part 110 is connected to the public servers 210 and 220 via a control line 112.

For instance, the router 120 is connected to the two Internet service providers ISP-A410 and ISP-B420 via wide area networks (WAN) 401 and 402. The ISP switching part 122 of the router 120 is connected to, for instance, the Internet service providers ISP-A410 and ISP-B420 via the wide area networks (WAN) 401 and 402. The Internet service providers ISP-A410 and ISP-B420 are connected to the Internet 500.

The routing control part 121 comprises basic routing functions that a general router has. The basic routing functions include, for instance, functions of referencing the destination address of a received packet, selecting a route from the routing table to deliver a packet, and forwarding a received packet on the route.

When the router 120 forwards a packet, the ISP switching part 122 determines which Internet service provider's line is used to connect to the Internet 500, the Internet service provider ISP-A410 or the Internet service provider ISP-B420, on the basis of information sent by the server monitoring part 110 via the control line 111.

The routing control part 121 receives via the control line 123 the Internet service provider determined by the ISP switching part 122 to be routed through and determines a delivery route on the basis of the destination of an outgoing packet, taking into consideration this Internet service provider to be routed through. Next, the routing control part 121 notifies the ISP switching part 122 of the determined delivery route via the control line 124.

The server monitoring part 110 measures and monitors a server load on the public servers 210 and 220 via the control line 112. When a CPU allocated for regular packet processing operations are also used to process packets generated by a denial-of-service (DOS) attack, the server load will increase and the public servers will become in a highly loaded state.

For instance, when a distributed denial-of-service (DDos) attack occurs,
the CPU/memory utilization of the public server 210 or 220 may sharply increase, or
the packet throughput at the public server 210 or 220 may sharply increase, or the like. Therefore, the CPU/memory utilization of the public servers 210 and 220 or the packet throughput at the public servers 210 and 220 may be monitored as a server load.

The server monitoring part 110 compares a measured server load on the public servers 210 and 220 with a threshold value, recognizes a high-load state when the server load is greater than the threshold value, and notifies information indicating the high-load state to the ISP switching part 122 via the control line 111.

Further, for the monitoring by the server monitoring part 110 of a server load on the public servers 210 and 220, an arbitrary wait time is set in order to ensure that a server load falls below the threshold value to be stabilized. After the server monitoring part 110 has once notified the ISP switching part 122 of the monitoring result, the server monitoring part 110 does not transmit a result of monitoring the server load on the public servers to the ISP switching part 122 until the set wait time has elapsed. In other words, after the server monitoring part 110 has notified the ISP switching part 122 of a monitoring result indicating a high-load state, the server monitoring part 110 does not perform to measure a server load and notify a monitoring result indicating a high-load state until the wait time for ensuring that the server load falls below the threshold value to be stabilized has elapsed.

By incorporating the above features, the router 120 of the control system 100 according to the first example embodiment of the present invention can switch the Internet service provider and forward a packet via the router 120 before a denial-of-service attack or a distributed denial-of-service attack deprives a margin of the processing capacity of the public server 210 or 220. In other words, the router is a router that disconnects communication established between the router and a first provider in a communication path between a public server and the first provider and establishes communication between a second provider and the router when a load on the public server satisfies a condition for switching the provider.

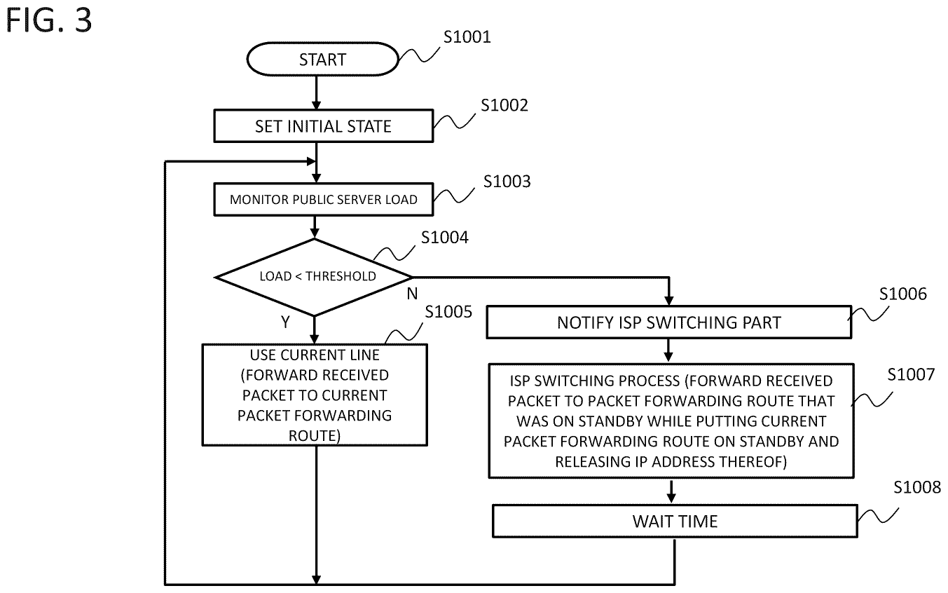

Next, the following describes an example of an outline of the operation of the control system of the first example embodiment of the present invention. FIG. 3 is a flowchart showing an example of an outline of an operation of the control system according to the first example embodiment of the present invention.

An example of an outline of an operation of a packet relay system using the router 120 of the control system 100 according to the first example embodiment of the present invention will be described using FIG. 3.

With reference to FIG. 3, the operation starts in step S1001.

In step S1002, an initial state is set. It is assumed that in the initial state, the router 120 is connected to the Internet 500 via the WAN 401, which is a first line of the wide area network, utilizing the first Internet service provider ISP-A410. Note, it is assumed that the router 120 can always switch to a state in which it is connected to the Internet 500 via the WAN 402, which is a second line of the wide area network, utilizing the second Internet service provider ISP-B420.

In step S1003, the server monitoring part 110 measures the CPU/memory utilization and the packet throughput of the public servers 210 and 220 via the control line 112 to monitor a server load.

Next, in step S1004, if the server load indicated by a measured value is less than a predetermined threshold value (the step S1004-Y), the router 120 continues to use the first Internet service provider ISP-A410 via the current line WAN 401 in step S1005. In other words, the router 120 forwards a received packet to the packet forwarding route of the current line WAN 401.

Meanwhile, in the step S1004, if the server load of the public servers indicated by a measured value is greater than or equal to the threshold value (the step S1004-N), the server monitoring part 110 notifies information indicating the recognized high-load state to the ISP switching part 122 of the router 120 in step S1006.

Next, in step S1007, the ISP switching part 122 of the router 120 performs an ISP switching process of switching from the first Internet service provider (ISP-A410) to the second Internet service provider (ISP-B420) in order to forward a packet on the second line WAN 402. In the ISP switching process, the ISP switching part 122 forwards a received packet to the packet forwarding route that was on standby, i.e., the packet forwarding route connecting to the Internet 500 utilizing the second Internet service provider ISP-B420 via the second line WAN 402 while putting on standby the current packet forwarding route, i.e., the packet forwarding route connecting to the Internet 500 utilizing the first Internet service provider ISP-A410 via the first line WAN 401 and releasing the IP address thereof.

Next, since the arbitrary wait time is set for the server monitoring part 110, the server monitoring part 110 does not generate any new notification in step S1008 until the predetermined wait time has elapsed after the ISP switching process has started in the step S1007. As a result, it is possible to prevent that, after the Internet service provider is switched and before the server load on the public servers falls below the threshold value to be stabilized, the server monitoring part 110 redetects a high-load state of the public server 210 or 220 and notifies information indicating the high-load state to the ISP switching part 122 of the router 120, whereby immediately after the ISP switching process is completed, the router 120 restarts the ISP switching process and repeats the same process continuously.

After the predetermined wait time has elapsed in the step S1008, the operation returns to the step S1003 and repeats the processes of the steps S1003 to S1008 described above again.

As described above, according to the first example embodiment of the present invention, an appropriate packet forwarding route can be selected by the routing control part 121 and the ISP switching part 122 of the router 120 in a case where a plurality of Internet service providers (ISPs) are subscribed whereby a plurality of routes can be selected.

In a system configuration that includes a public server subscribing to at least two Internet service providers, the control system according to the first example embodiment of the present invention is able to monitor a server load by measuring the usage of the public server and automatically switch the Internet service provider as an initial response before an increase in the server load affects the services provided by the public server.

An IP address is assigned to a router or public server by an Internet service provider. By switching an Internet service provider, the IP address assigned by the Internet service provider before the switch is changed to another IP address assigned by another Internet service provider after the switch. The IP address assigned by the Internet service provider before the switch is configured to allow communication from external sources. For instance, it is published by a DNS server. The IP address assigned by another Internet service provider after the switch, however, is not configured to allow communication from external sources. Therefore, switching the Internet service provider makes it impossible to communicate the public server from external sources.

As a result, when a denial-of-service attack on a public server is detected due to an increase in a server load on a public server, it is possible to take measures to prevent denial-of-service attacks thereafter without operator intervention and suppress an increase in a processing amount of malicious packets in a router.

Therefore, the control system of the first example embodiment of the present invention can cope with an increase in packet throughput for a public server. Further, it is possible to provide a control system that contributes to enabling the suppression of an increase in a processing amount of malicious packets in a router by detecting a rapid decrease in a processing capacity of a public server due to a denial-of-service attack and the like.

Further, switching the Internet service provider allows for continued communication with the Internet, unlike, for instance, in a case where the communication is disconnected. In addition, switching the Internet service provider can reduce cost and time required to an addressing in comparison to a case where a dedicated communication line is installed, for instance.

Moreover, by switching the Internet service provider, it is possible to perform communication over a wider bandwidth than using a tethering or dial-up feature on a smartphone, for instance.

### Second Example Embodiment

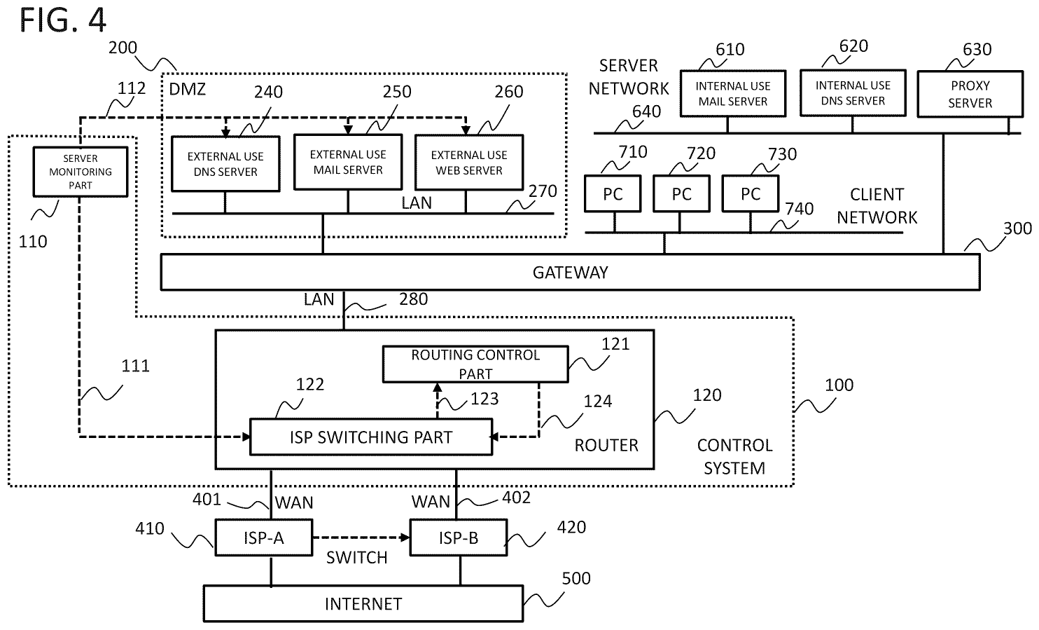

Next, a second example embodiment of the present invention will be described. FIG. 4 is a diagram illustrating a schematic configuration of an example of utilizing a control system according to the second example embodiment of the present invention.

In FIG. 4, components with the same reference signs as those in FIG. 2 indicate the same components, and the descriptions thereof will be omitted. In the second example embodiment of the present invention, solid lines indicate data lines and dotted lines indicate control lines, respectively. Note a server monitoring part 110 of a control system 100 may be configured to be provided independently of the router 120 and be connected to the router 120 by a network and so on. Alternatively, the control system 100 as a control apparatus may be configured to include the server monitoring part 110 and the router 120 provided therein. Further, a server published on the Internet is also referred to as a public server in the second example embodiment of the present invention.

With reference to FIG. 4, in a DMZ (DeMilitarized Zone) 200, there are an external-use DNS server 240, an external-use mail server 250, and an external-use Web server 260 provided as public servers subscribing to at least two Internet service providers ISP-A410 and ISP-B420, and the external-use DNS server 240, the external-use mail server 250, the external-use Web server 260, and a gateway 300 are connected to a local area network (LAN) 270. The server monitoring part 110 is connected to the external-use DNS server 240, the external-use mail server 250, and the external-use Web server 260 via a control line 112. Further, personal computers (PCs) 710, 720, and 730 are connected to a client network 740, which is connected to the gateway 300. In addition, an internal-use mail server 610, an internal-use DNS server 620, and a proxy server 630 are connected to a server network 640, which is connected to the gateway 300. The client network 740 and the server network 640 may also be referred to as internal networks. The DMZ 200 includes the local area network (LAN) 270. Further, the DMZ 200 is separated from the internal networks by the gateway 300. Elements other than the DMZ 200 and the internal networks may be referred to be external, which include, for instance, the Internet.

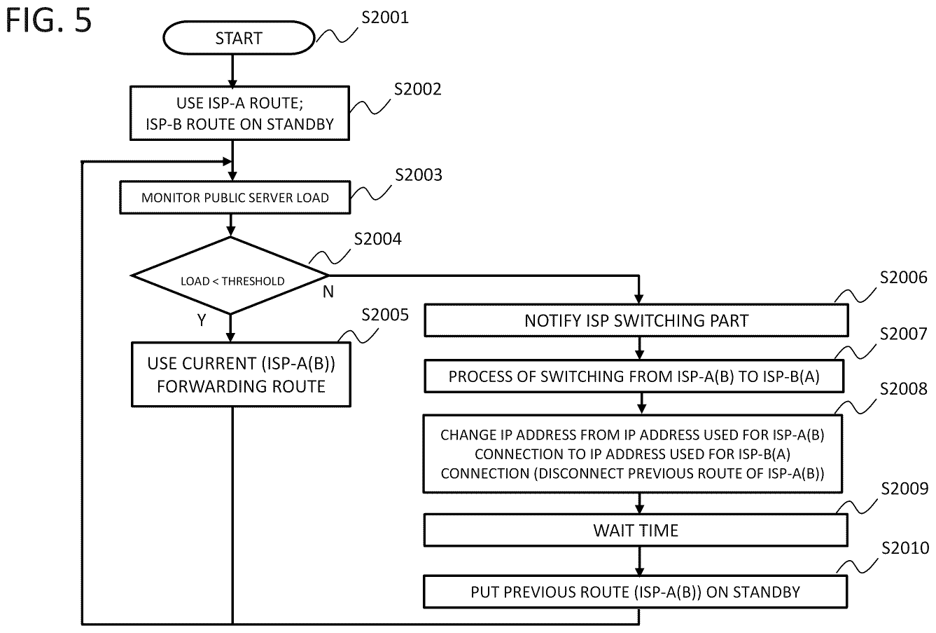

Next, using FIG. 5, the following describes an outline operation of an example of utilizing the control system according to the second example embodiment of the present invention. FIG. 5 is a flowchart showing an example of the outline operation of an example of utilizing the control system according to the second example embodiment of the present invention.

With reference to FIG. 5, the operation starts in step S2001.

It is assumed that, in step S2002, a packet forwarding route via the Internet service provider ISP-A410 is used, and a packet forwarding route via the Internet service provider ISP-B420 is on standby.

In step S2003, the server monitoring part 110 shown in FIG. 4 measures the usage such as the CPU/memory utilization and the packet throughput of the public servers such as the external-use DNS server 240, the external-use mail server 250, and the external-use Web server 260 via the control line 112 to monitor the server load.

Next, in step S2004, if the server load indicated by a measured value is less than a set threshold value (the step S2004-Y), the operation is determined to be in a normal operating condition then, in step S2005, accesses, i.e., services, are continued using a packet forwarding route via the current Internet service provider ISP-A410.

Meanwhile, when the server load indicated by a measured value of the external-use DNS server 240, the external-use mail server 250, and the external-use Web server 260 in the DMZ 200, which are externally published, reaches a high-load state equal to or greater than the threshold value (the step S2004-N), the server monitoring part 110 determines that a denial-of-service attack is being received from an attacker and notifies information indicating the high-load state to the ISP switching part 122 of the router 120 in step S2006.

Next, in step S2007, the ISP switching part 122 switches from the packet forwarding route via the current Internet service provider ISP-A410 to the one via the Internet service provider ISP-B420 that was on standby.

When the packet forwarding route is switched in the step S2007, the packet forwarding route via the Internet service provider ISP-A410, which was the packet forwarding route before the switch, is disconnected in step S2008. Concretely, the IP address is changed from the one used for the connection via the Internet service provider ISP-A410 to the IP address used for the connection via the Internet service provider ISP-B420, and the packet forwarding route before the switch via the Internet service provider ISP-A410 is disconnected.

Next, because an arbitrary wait time is set for the server monitoring part 110, the server monitoring part 110 does not generate any new notification of information to the ISP switching part 122 in step S2009 until the wait time has elapsed after the ISP switching process has started in the step S2007.

The IP address is changed in the switch process described above, and because the new IP address is not linked to the URLs of the external-use DNS server 240, the external-use mail server 250, and the external-use Web server 260 in the DMZ 200, which are externally published, from the attacker's point of view, the attacker cannot launch an attack. Even after the Internet service provider has been switched, however, it is possible to deliver packets transmitted from the PCs 710, 720, and 730 in the client network within the system to the Internet 500. Further, the PCs 710, 720, and 730 in the client network within the system are able to maintain access to the Internet 500 by the internal-use DNS server in the server network 640 even after the ISP switch.

During an attack on the external-use DNS server 240, the external-use mail server 250, and the external-use web server 260 by the attacker, not only the load of these servers increases but also a load of router 120, which forwards malicious packets sent during the attack, increases. However, because IP addresses of the external-use DNS server 240, the external-use mail server 250, the external-use web server 260, and the router 120 are changed by the ISP switch, the malicious packets sent during the attack are no longer delivered to the router 120, whereby the load of the router 120 is reduced. This prevents the attack by the attacker from affecting access from the PCs 710, 720, and 730 to the Internet 500.

Next, in step S2010, the packet forwarding route via the Internet service provider ISP-A410, which was the packet forwarding route before the switch, is put on standby, and the operation returns to the step S2003 and uses the packet forwarding route via the Internet service provider ISP-B420 as the current packet forwarding route, repeating the processes described above again with the packet forwarding route via the Internet service provider ISP-A410 on a standby state.

Therefore, the control system of the second example embodiment of the present invention is also able to contribute to enabling the suppression of an increase in a processing amount of malicious packets in a router by detecting a rapid decrease in a processing capacity of a public server provided in the DMZ due to a denial-of-service attack and the like in the example of utilizing the control system according to the second example embodiment of the present invention.

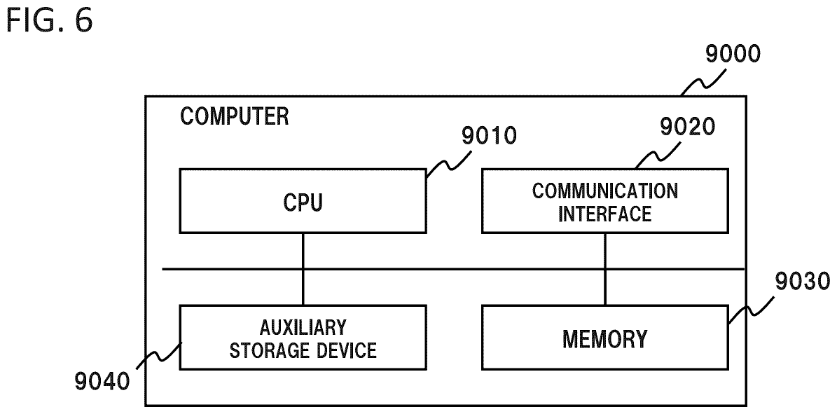

Further, procedures described in the first and the second example embodiments above can be realized by a program causing a computer (9000 in FIG. 6) that functions as the control system 100 to realize functions as the control system 100. Such computer is illustrated by a configuration, as an example, including a CPU (Central Processing Unit) 9010, a communication interface 9020, a memory 9030, and an auxiliary storage device 9040 in FIG. 6. Namely, the CPU 9010 in FIG. 6 may execute a control program and to perform processing for updating various calculation parameter stored in the auxiliary storage device 9040 or the like.

The memory 9030 is a RAM (Random Access Memory), a ROM (Read-Only Memory), and the like.

Namely, an individual part (processing means, function) of the control system described in the first and the second example embodiment above can be realized by a computer program that causes a processor of the computer to execute each of the processes described above by using its hardware.

Finally, suitable modes of the present invention will be summarized.

### [Mode 1]

(Refer to the control system according to the first aspect.)

### [Mode 2]

In the control system according to Mode 1, it is preferable that the server monitoring part notifies the load information when a load on the public server is equal to or greater than a predetermined threshold value.

### [Mode 3]

In the control system according to Mode 1 or 2, it is preferable that the server monitoring part does not generate a new notification of load information until a predetermined time has elapsed since the load information has been notified.

### [Mode 4]

In the control system according to any one of Modes 1 to 3, it is preferable that the selectin part blocks a delivery route via the line of the Internet service provider used before the selection when the delivery of a transmission packet has been started through a delivery route via the line of the selected Internet service provider.

### [Mode 5]

In the control system according to any one of Modes 1 to 4, it is preferable that the router delivers a packet transmitted by a computer provided in an internal network to an Internet through a line of the Internet service provider selected by the selection part.

### [Mode 6]

(Refer to the control method according to the second aspect.)

### [Mode 7]

In the control method according to Mode 6, it is preferable that the server monitoring step comprises notifying the load information when a load on the public server is equal to or greater than a predetermined threshold value.

### [Mode 8]

In the control method according to Mode 6 or 7, it is preferable that the server monitoring step comprises not generating a new notification of load information until a predetermined time has elapsed since the load information has been notified.

### [Mode 9]

(Refer to the program according to the third aspect.)

### [Mode 10]

In the program according to Mode 9, it is preferable that the server monitoring process comprises notifying the load information when a load on the public server is equal to or greater than a predetermined threshold value.

### [Mode 11]

In the program according to Mode 9 or 10, it is preferable that the server monitoring process comprises not generating a new notification of load information until a predetermined time has elapsed since the load information has been notified.

### [Mode 12]

A router, that disconnects communication established between the router and a first provider in a communication path between a public server and the first provider and establishes communication between a second provider and the router, when a load on the public server satisfies a condition for switching a provider.

Further, as Mode 1, Modes 6 and 9 can be expanded into Mode 4 or 5.

The disclosure of each of the above Patent Literatures is incorporated herein by reference thereto and is considered to be described therein. Variations and adjustments of the example embodiments and examples are possible within the scope of the overall disclosure (including the claims) of the present invention and based on the basic technical concept of the present invention. Various combinations and selections of various disclosed elements (including the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### REFERENCE SIGNS LIST

100: control system
110: server monitoring part
120: router
121: routing control part
122: Internet service provider (ISP) switching part
200: DMZ (DeMilitarized Zone)
210, 220: public server
240: external-use DNS server
250: external-use mail server
260: external-use Web server
270: local area network (LAN)
280: local area network (LAN)
300: gateway
401, 402: wide area network (WAN)
410: Internet service provider ISP-A
420: Internet service provider ISP-B
500: Internet
610: internal-use mail server
620: internal-use DNS server
630: proxy server
640: server network
710, 720, 730: personal computer (PC)
740: client network
9000: computer
9010: CPU
9020: communication interface
9030: memory
9040: auxiliary storage device

What is claimed is:

1. A control system, comprising:
at least a processor; and
a memory in circuit communication with the processor,
wherein the processor is configured to execute program instructions stored in the memory to perform:
monitoring a public server accessible via lines of at least two Internet service providers; and
routing, wherein
the monitoring comprises notifying load information indicating a load state of the public server, and
the routing comprises:
selecting an Internet service provider according to the load information notified by the monitoring; and
determining a delivery route in such a way that a packet is delivered through a line of the Internet service provider selected by the selecting.

2. The control system according to claim 1, wherein the monitoring comprises notifying the load information when a load on the public server is equal to or greater than a predetermined threshold value.

3. The control system according to claim 1, wherein the monitoring comprises not generating a new notification of load information until a predetermined time has elapsed since the load information has been notified.

4. The control system according to claim 1, wherein the selecting comprises blocking a delivery route via the line of the Internet service provider used before the selection when the delivery of a transmission packet has been started through a delivery route via the line of the selected Internet service provider.

5. The control system according to claim 1, wherein the routing comprises delivering a packet transmitted by a computer provided in an internal network to an Internet through a line of the Internet service provider selected by the selecting.

6. A control method, comprising: executed by a computer,
monitoring a public server accessible via lines of at least two Internet service providers;
wherein the monitoring comprises notifying load information indicating a load state of the public server;
selecting an Internet service provider according to the load information notified by the server monitoring step; and
determining a delivery route in such a way that a packet is delivered through a line of the Internet service provider selected by the selecting.

7. The control method according to claim 6, wherein the monitoring comprises notifying the load information when a load on the public server is equal to or greater than a predetermined threshold value.

8. The control method according to claim 6, wherein the monitoring comprises not generating a new notification of load information until a predetermined time has elapsed since the load information has been notified.

9. A computer-readable non-transitory recording medium recording a program, the program causing a computer to execute:
a server monitoring process of monitoring a public server accessible via lines of at least two Internet service providers;
wherein the server monitoring process comprises notifying load information indicating a load state of the public server;
a selection process of selecting an Internet service provider according to the load information notified by the server monitoring process; and
a control process of determining a delivery route in such a way that a packet is delivered through a line of the Internet service provider selected by the selection process.

10. The medium according to claim 9, wherein the server monitoring process comprises notifying the load information when a load on the public server is equal to or greater than a predetermined threshold value.

11. The medium according to claim 9, wherein the server monitoring process comprises not generating a new notification of load information until a predetermined time has elapsed since the load information has been notified.

12. A router, that disconnects communication established between the router and a first provider in a communication path between a public server and the first provider and establishes communication between a second provider and the router, when a load on the public server satisfies a condition for switching a provider.

13. The control method according to claim 6, wherein the selecting comprises blocking a delivery route via the line of the Internet service provider used before the selection when the delivery of a transmission packet has been started through a delivery route via the line of the selected Internet service provider.

14. The control method according to claim 6, comprising: executed by a computer,
delivering a packet transmitted by a computer provided in an internal network to an Internet through a line of the Internet service provider selected by the selecting.

15. The medium according to claim 9, wherein the selection process comprises blocking a delivery route via the line of the Internet service provider used before the selection when the delivery of a transmission packet has been started through a delivery route via the line of the selected Internet service provider.

16. The medium according to claim 9, wherein the program causing the computer to execute:
a process of delivering a packet transmitted by a computer provided in an internal network to an Internet through a line of the Internet service provider selected by the selection process.

17. The router according to claim 12, that blocks a delivery route via the line of the Internet service provider used before the selection when the delivery of a transmission packet has been started through a delivery route via the line of the selected Internet service provider.

18. The router according to claim 12, that delivers a packet transmitted by a computer provided in an internal network to an Internet through a line of the selected Internet service provider.
